(19) United States
(12) Patent Application Publication
(10) Pub. No.: US 2026/0034658 A1
(43) Pub. Date: Feb. 5, 2026

(54) ROTARY TOOL WITH GRIP ZONE SPEED CONTROL

(71) Applicant: Robert Bosch GmbH, Stuttgart (DE)

(72) Inventor: Kevin Wasielewski, Downers Grove, IL (US)

(21) Appl. No.: 18/790,782

(22) Filed: Jul. 31, 2024

(51) Int. Cl. B25F 5/00; B25F 5/02

(52) U.S. Cl. CPC B25F 5/001; B25F 5/02

(57) ABSTRACT

A rotary tool includes a housing defining an axis and including a forward end portion, a rearward end portion, and a pencil-grip portion adjacent the forward end portion. The pencil-grip portion is configured to be gripped by a hand of a user in a pencil-grip. A first speed control is positioned rearwardly of the pencil-grip portion and extends through or is accessible through the housing. A second speed control is positioned between the forward end portion and the first speed control along the axis and extends through or is accessible through the housing. The second speed control is configured to be manipulated by the hand, following gripping of the rotary tool by the hand in the pencil-grip, without fully releasing the pencil-grip.

### FIELD

The present disclosure relates generally to hand-held power tools.

### BACKGROUND

Hand-held power tools, and in particular rotary power tools, are commonly used to perform detailed applications like engraving, carving, and polishing. When preforming detailed applications by hand using hand-held power tools, fine details are typically best accomplished using tools provided with what is known as a “pencil-grip” wherein a user grasps a tool in one hand using, in particular, a thumb and one or both of a forefinger and middle finger to control the tool in a grip similar to a grip used in holding a pencil.

While very effective in providing control, hand-held tools incorporating a pencil-grip do exhibit some drawbacks. One such drawback is in speed control. In particular, hand-held power tools typically include a speed control which is located rearwardly of the grip zone or grip portion of the tool. Accordingly, use of the tool is accomplished by grasping the tool with one hand while using the other hand to energize the tool and to modify the speed of rotation of the device by manipulating the speed control. The detailed application is then commenced.

So long as no further speed modification is required, the detailed application can proceed until it is finished. In some instances. however, increased speed is desired. The increased speed may be desired simply to remove material faster, or to adapt the tool to variations in material density/hardness such as when encountering a knot or grain pattern in wood. By way of example, while forming fine details and outlines of an area, a low rate of material removal, and hence a lower speed, is generally used. For rough detail and removal of material within the boundaries of an area, faster material removal, and hence faster speed, is typically desired. To adapt the speed of the tool to address these issues, the user must adjust the speed control. Modification of the speed control, however, requires moving the hand not holding the tool between the user's eyes and the workpiece. Mistakes can be made when the user loses sight of the workpiece while continuing material removal. Alternatively, the user must first stop removing material, modify the speed, and then restart the detailed application. Neither situation is optimal.

Moreover, in instances wherein the non-gripping hand of the user is used to steady a workpiece, the workpiece must be positioned in a safe location before the speed of the hand-held power tool can be modified. This causes a delay in the detailed application.

What is needed is a hand-held power tool which ameliorates one or more of the above identified shortcomings. It would be beneficial if the hand-held power tool allowed for controlled temporary increases of power without obscuring a user's sightline to a workpiece. It would be further advantageous if power/speed of the hand-held power tool could be modified using the same hand which is used to grip the hand-held power tool.

### SUMMARY

According to one embodiment of the present disclosure, a rotary tool includes a housing, which can be generally cylindrical, defining an axis and including a forward end portion, a rearward end portion, and a pencil-grip portion (also referred to as a “zone”) adjacent the forward end portion. The pencil-grip portion is configured to be gripped by a hand of a user in a pencil-grip. A first speed control is positioned rearwardly of the pencil-grip portion and extends through or is accessible through the housing. A second speed control is positioned between the forward end portion and the first speed control along the axis and extends through or is accessible through the housing. The second speed control is configured to be manipulated by the hand, following gripping of the rotary tool by the hand in the pencil-grip, without fully releasing the pencil-grip.

In one or more embodiments, the rotary tool is a hand-held power tool.

In one or more embodiments the first speed control is configured to set a base speed of a motor located within the housing, and the second speed control is configured to modify the speed of the motor from the base speed.

In one or more embodiments the pencil-grip portion includes a first and a second grip region radially spaced about the housing. The first grip region is configured to be contacted by a first finger of the hand when the rotary tool is gripped by the hand of the user in the pencil-grip. The second grip region is configured to be contacted by a thumb of the hand when the rotary tool is gripped by the hand of the user in the pencil-grip. The second speed control is positioned to be manipulated by one of the first finger, a second finger of the hand, or the thumb following the gripping of the rotary tool by the hand in the pencil-grip, without fully releasing the pencil-grip.

In one or more embodiments the second speed control is positioned at or near a forward portion of the first grip region at a location radially offset from a position of the first finger when the rotary tool is gripped by the hand of the user in the pencil-grip.

In one or more embodiments the second speed control is positioned at or near the first grip region at a first location offset from a position of the first finger along the axis when the rotary tool is gripped by the hand of the user in the pencil-grip such that the second speed control is manipulated by rolling or moving the first finger or the second finger along the axis when the rotary tool is gripped by the hand of the user in the pencil-grip. Alternatively, the second speed control is positioned at or near the second grip region at a second location offset from a position of the thumb along the axis when the rotary tool is gripped by the hand of the user in the pencil-grip such that the second speed control is manipulated by rolling the thumb along the axis when the rotary tool is gripped by the hand of the user in the pencil-grip.

In one or more embodiments the second speed control comprises a push button extending outwardly of the housing.

In one or more embodiments the second speed control is configured to increase speed of the motor to a second speed greater than the base speed when the second speed control is manipulated.

In one or more embodiments the second speed control is configured to select any of a plurality of motor speeds when manipulated, each of the plurality of motor speeds greater than the base speed.

In one or more embodiments a bulbous portion of the forward end portion of the housing is located immediately forwardly of the pencil-grip portion.

### BRIEF DESCRIPTION OF THE DRAWINGS

The above-described features and advantages, as well as others, will become more readily apparent to those of ordinary skill in the art by reference to the following detailed description and accompanying drawings.

FIG. 1 depicts a side plan view of a rotary tool in the form of a hand-held power tool with two speed controls extending from or accessible through a housing of the hand-held power tool, one of the speed controls located between a pistol-grip portion and a rear portion of the housing, and the other speed control located within the pistol-grip portion of the housing;

FIG. 2. depicts a perspective partial exploded view of the rotary tool of FIG. 1 showing a motor, control board, and battery located within the housing of the rotary tool;

FIG. 3 depicts a schematic view of a control circuit for the rotary tool of FIG. 1;

FIG. 4 depicts a partial side perspective view of the rotary tool of FIG. 1 held by a user in a pistol-grip using two fingers and a thumb;

FIG. 5 depicts a partial side perspective view of an alternative rotary tool with two speed controls extending from or accessible through a housing of a hand-held power tool, one of the speed controls located between a pistol-grip portion and a rear portion of the housing, and the other speed control located within the pistol-grip portion of the housing, held by a user in a pistol-grip using a single finger and a thumb; and

FIG. 6 depicts a partial side perspective view of an alternative rotary tool with two speed controls extending from or accessible through a housing of a hand-held power tool, one of the speed controls located between a pistol-grip portion and a rear portion of the housing, and the other speed control located within the pistol-grip portion of the housing, held by a user in a pistol-grip using two fingers and a thumb;

### DETAILED DESCRIPTION

For the purpose of promoting an understanding of the principles of the disclosure, reference will now be made to the embodiments illustrated in the drawings and described in the following written description. It is to be understood that no limitation to the scope of the disclosure is thereby intended. It is further to be understood that the present disclosure includes any alterations and modifications to the illustrated embodiments and includes further applications of the principles of the disclosure as would normally occur to one skilled in the art to which this disclosure pertains.

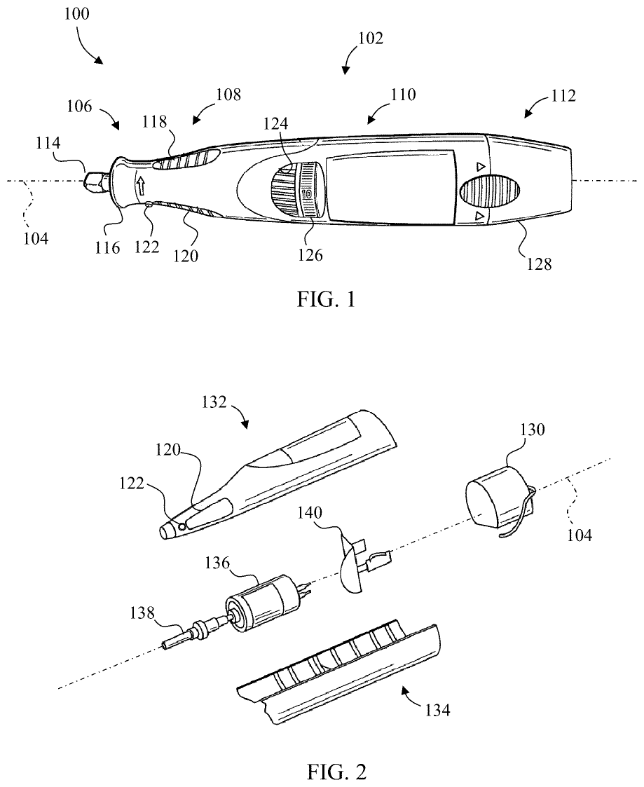

FIG. 1 depicts a rotary tool in the form of a hand-held power tool 100. The hand-held power tool includes a housing 102, which in this embodiment is generally cylindrical, which extends along an axis 104. The housing 102 includes a forward end portion 106, a pencil-grip portion 108, a middle portion 110, and a rearward end portion 112.

A tool holder in the form of a chuck 114 extends forwardly of the forward end portion 106. A bulbous portion 116 of the forward end portion 106 of the housing 102 is located immediately forwardly of the pencil-grip portion 108.

The pencil-grip portion 108 includes two grip regions 118/120 which are radially offset from one another about the axis 104. A speed control in the form of a push button speed control 122 extends outwardly from the pencil-grip portion 108 of the housing 102. In some embodiments, the speed control 122 is accessible through the housing 102.

The middle portion 110 of the housing 102 defines a window 124 through which a second speed control in the form of a slide switch 126 which in this embodiment is a combined speed and power controller. In embodiments in which the speed control 122 is accessible through the housing 102, a similar window is provided. The speed control 122 in such embodiments can be a push button type control or any other desired type of control. By way of example, in some embodiments the speed control is one of a pressure switch, variable speed trigger, rotary dial (e.g., potentiometer), etc.

The rearward end portion 112 includes a removable cover 128. The removable cover 128 provides access to a battery 130 (see FIG. 2) which is positioned within the rearward end portion 112. In some embodiments, the rearward end portion 112 is configured to permit charging of the battery 130 and the removable cover 128 is omitted. In other embodiments, the removable cover 128 allows for removal of the battery 130 for charging or replacement. In still further embodiments, a corded connection is provided in lieu of, or in addition to, the battery 130.

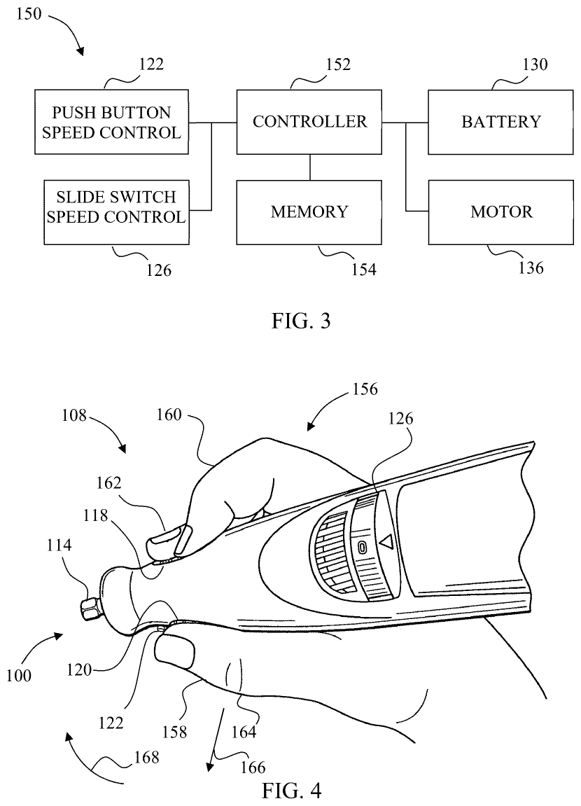

As shown in FIG. 2, the housing 102 in this embodiment includes two clamshell housing portions 132/134 which define at least portions of the forward end portion 106, the pencil-grip portion 108, and the middle portion 110. A motor 136 is housed within the middle portion 110 and includes an output shaft 138 which is operably connected to the chuck 114. A control board 140 is also positioned within the middle portion 110. At least a portion of a control circuit 150 (see FIG. 3) is provided on the control board 140.

The control circuit 150 shown in FIG. 3 includes a controller 152 which is operably connected to a memory 154 in which program instructions are stored. The controller 152 is configured to execute the program instructions to perform the processes described herein. The controller 152 is further operably connected to the push button speed control 122, the slide switch speed control 126, the battery 130, and the motor 136.

To use the hand-held power tool 100 in a detailed application, a user first uses one hand 156 to grip the hand-held power tool 100 as shown in FIG. 4. In FIG. 4, the user has grasped the hand-held power tool 100 between a thumb 158 positioned on the grip region 120, and a forefinger 160 and a middle finger 162 positioned on the grip region 118. The grip regions 118/120 in some embodiments are formed of a material conducive to enhancing gripping such as a rubber product. In other embodiments the grip regions are simply textured portions of the housing 102. The grip portions provide a visual aid to the user as to proper positioning of the thumb 158, the forefinger 160 and the middle finger 162 on the pencil-grip portion 108.

The user then uses the non-gripping hand to manipulate the slide switch speed control 126. In response, the controller 152 controls application of power from the battery 130 to the motor 136 to achieve a base speed associated with the position of the slide switch 126. Rotation of the motor 136 causes the chuck 114 to rotate thereby rotating a working tool/accessory (not shown) positioned in the chuck 114. The user then uses the hand-held power tool 100 to perform a detailed application.

When the user desires increased speed (or decrease) from the hand-held power tool 100 during the detailed application, the user simply pinches the thumb 158, the forefinger 160 and the middle finger 162 on the pencil-grip portion 108 such that the thumb joint 164 moves in the direction of the arrow 166 (see FIG. 4). This causes the thumb 158 to roll in the direction of the arrow 168 relative to the grip region 120 thereby depressing the push button speed control 122. In response, the controller 152 controls the motor 136 to increase (or decrease) speed based upon the program instructions stored in the memory 154. The ability to selectively increase (or decrease) speed is particularly useful in smaller sized lower powered rotary tools. In some embodiments, the increase (or decrease) in speed is achieved while maintaining a constant torque, while in other embodiments torque is reduced (or increased) to maintain a constant power.

In some embodiments, execution of the program instructions by the controller 152 results in a single set increase (or decrease) in speed from the base speed for a predetermined period of time. In some embodiments, execution of the program instructions results in a single set increase (or decrease) in speed from the base speed for so long as the push button speed control 122 is depressed. In some embodiments, in response to rapid sequential depressions of the push button speed control 122, execution of the program instructions results in a respective incremental increase (or decrease) in speed from the base speed for each of the rapid sequential depressions of the push button speed control 122. A return to the base speed may be controlled based upon time, release of the push button speed control 122, or a later further depression of the push button speed control 122. In some embodiments, the push button speed control is replaced with a force switch or a multiple variable trigger type switch to allow for additional ranges of increased motor speed.

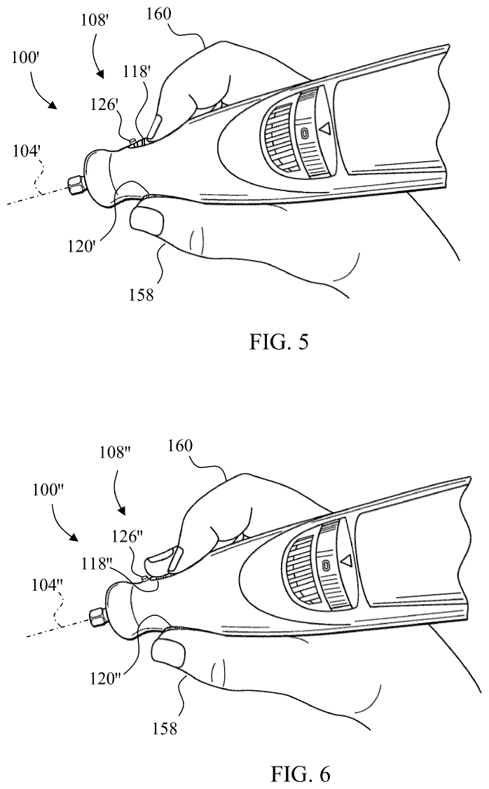

While the embodiment of FIG. 1 shows the push button speed control switch 126 positioned for actuation by a thumb, in some embodiments the push button speed control switch is positioned for use by one or more of the forefinger and the middle finger. Such positions are particularly useful when the pencil-grip is effected using only a finger and a thumb. By way of example, FIG. 5 depicts a hand-held power tool 100′ which is identical to the hand-held power tool 100 with the exception of the placement of the push button speed control switch. In FIG. 5, the push button speed control switch 126′ is aligned with the grip region 118′ along the axis 104′, but radially offset from the grip region 118′. This configuration is useful when a user uses the thumb 158 and the forefinger 160 to grip the pencil-grip portion 108′ in a pencil-grip. The user then uses the middle finger 162 to selectively depress the push button speed control switch 126′.

In a further embodiment the push button speed control switch is positioned for use by the middle finger when the pencil-grip is effected using two fingers and a thumb. By way of example, FIG. 6 depicts a hand-held power tool 100″ which is identical to the hand-held power tool 100 with the exception of the placement of the push button speed control switch. In FIG. 6, the push button speed control switch 126″ is aligned with the grip region 118″ along the axis 104″. In this configuration, the user rolls the middle finger 162 to selectively depress the push button speed control switch 126″ in a manner similar to the rolling of the thumb 158 discussed above. Alternatively, the user may simply move the middle finger 162 forwardly to selectively depress the push button speed control switch 126″. As in each of the previous embodiments, the embodiment of

FIG. 6 allows a user to modify the speed of the hand-held power tool by one of the forefinger, the middle finger, or the thumb following the gripping of the rotary tool by the hand in the pencil-grip using two or three fingers, without fully releasing the pencil-grip.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. A rotary tool, comprising:
a housing defining an axis and including a forward end portion, a rearward end portion, and a pencil-grip portion adjacent the forward end portion, the pencil-grip portion configured to be gripped by a hand of a user in a pencil-grip;
a first motor speed control positioned rearwardly of the pencil-grip portion and extending through or accessible through the housing; and
a second motor speed control positioned between the forward end portion and the first motor speed control along the axis and extending through or accessible through the housing, the second motor speed control configured to be manipulated by the hand, following gripping of the rotary tool by the hand in the pencil-grip, without fully releasing the pencil-grip.

2. The rotary tool of claim 1, wherein:
the first motor speed control is configured to set a non-zero base speed of a motor located within the housing; and
the second motor speed control is configured to modify the speed of the motor from the non-zero base speed.

3. The rotary tool of claim 2, wherein:
the pencil-grip portion includes a first and a second grip region radially spaced about the housing;
the first grip region is configured to be contacted by a first finger of the hand when the rotary tool is gripped by the hand of the user in the pencil-grip;
the second grip region is configured to be contacted by a thumb of the hand when the rotary tool is gripped by the hand of the user in the pencil-grip; and
the second motor speed control is positioned to be manipulated by one of the first finger, a second finger of the hand, or the thumb following the gripping of the rotary tool by the hand in the pencil-grip, without fully releasing the pencil-grip.

4. The rotary tool of claim 3, wherein the second motor speed control is positioned at or near a forward portion of the first grip region at a location radially offset from a position of the first finger when the rotary tool is gripped by the hand of the user in the pencil-grip.

5. The rotary tool of claim 3, wherein:
the second motor speed control is positioned at or near the first grip region at a first location offset from a position of the first finger along the axis when the rotary tool is gripped by the hand of the user in the pencil-grip such that the second motor speed control is manipulated by rolling or moving the first finger or the second finger along the axis when the rotary tool is gripped by the hand of the user in the pencil-grip; or
the second motor speed control is positioned at or near the second grip region at a second location offset from a position of the thumb along the axis when the rotary tool is gripped by the hand of the user in the pencil-grip such that the second motor speed control is manipulated by rolling the thumb along the axis when the rotary tool is gripped by the hand of the user in the pencil-grip.

6. The rotary tool of claim 5, wherein the second motor speed control comprises a push button extending outwardly of the housing.

7. The rotary tool of claim 6, wherein the second motor speed control is configured to increase speed of the motor to a second speed greater than the base speed when the second motor speed control is manipulated.

8. The rotary tool of claim 5, wherein the second motor speed control is configured to select any of a plurality of motor speeds when manipulated, each of the plurality of motor speeds greater than the base speed.

9. The rotary tool of claim 5, wherein a bulbous portion of the forward end portion of the housing is located immediately forwardly of the pencil-grip portion.

10. A hand-held power tool, comprising:
a housing defining an axis and including a forward end portion, a rearward end portion, and a pencil-grip portion adjacent the forward end portion, the pencil-grip portion configured to be gripped by a hand of a user in a pencil-grip;
a first motor speed control positioned rearwardly of the pencil-grip portion and extending through or accessible through the housing; and
a second motor speed control positioned between the forward end portion and the first motor speed control along the axis and extending through or accessible through the housing, the second motor speed control configured to be manipulated by the hand, following the gripping of the hand-held power tool by the hand in the pencil-grip, without fully releasing the pencil-grip.

11. The hand-held power tool of claim 10, wherein:
the first motor speed control is configured to set a non-zero base speed of a motor located within the housing; and
the second motor speed control is configured to modify the non-zero speed of the motor from the base speed.

12. The hand-held power tool of claim 11, wherein:
the pencil-grip portion includes a first and a second grip region radially spaced about the housing;
the first grip region is configured to be contacted by a first finger of the hand when the hand-held power tool is gripped by the hand of the user in the pencil-grip;
the second grip region is configured to be contacted by a thumb of the hand when the hand-held power tool is gripped by the hand of the user in the pencil-grip; and
the second motor speed control is positioned to be manipulated by one of the first finger, a second finger of the hand, or the thumb following the gripping of the hand-held power tool by the hand in the pencil-grip, without fully releasing the pencil-grip.

13. The hand-held power tool of claim 12, wherein the second motor speed control is positioned at or near a forward portion of the first grip region at a location radially offset from a position of the first finger when the hand-held power tool is gripped by the hand of the user in the pencil-grip.

14. The hand-held power tool of claim 12, wherein:
the second motor speed control is positioned at or near the first grip region at a first location offset from a position of the first finger along the axis when the hand-held power tool is gripped by the hand of the user in the pencil-grip such that the second motor speed control is manipulated by moving or rolling the first finger or the second finger along the axis when the hand-held power tool is gripped by the hand of the user in the pencil-grip; or
the second motor speed control is positioned at or near the second grip region at a second location offset from a position of the thumb along the axis when the hand-held power tool is gripped by the hand of the user in the pencil-grip such that the second motor speed control is manipulated by rolling the thumb along the axis when the hand-held power tool is gripped by the hand of the user in the pencil-grip.

15. The hand-held power tool of claim 14, wherein the second motor speed control comprises a push button extending outwardly of the housing.

16. The hand-held power tool of claim 15, wherein the second motor speed control is configured to increase speed of the motor to a second speed greater than the base speed when the second motor speed control is manipulated.

17. The hand-held power tool of claim 14, wherein the second motor speed control is configured to select any of a plurality of motor speeds when manipulated, each of the plurality of motor speeds greater than the base speed.

18. The hand-held power tool of claim 14, wherein a bulbous portion of the forward end portion of the housing is located immediately forwardly of the pencil-grip portion.

19. The hand-held power tool of claim 11, wherein:
the first motor speed control is configured as a slide switch; and
the second motor speed control comprises a push button extending outwardly of the housing.

20. The rotary tool of claim 2, wherein:
the first motor speed control is configured as a slide switch; and
the second motor speed control comprises a push button extending outwardly of the housing.
